(19) United States
(12) Patent Application Publication
(10) Pub. No.: US 2026/0195698 A1
(43) Pub. Date: Jul. 9, 2026

(54) Method for deriving displayed time slots based on individual lister criteria

(71) Applicant: Jaskiran S Mangat, Sequim, WA (US)

(72) Inventor: Jaskiran S Mangat, Sequim, WA (US)

(21) Appl. No.: 19/012,675

(22) Filed: Jan. 7, 2025

(51) Int. Cl. G06Q 10/083; G06Q 10/087

(52) U.S. Cl. CPC G06Q 10/083; G06Q 10/08741

(57) ABSTRACT

Smartphone-based, application system where an individual rents based on name of the stuff listed, yielding price and earliest time item is available. Invention relates to delivery and pick up method where invention algorithm can ascertain earliest time slot available based on the lister's choice and incorporate an individualized pickup/delivery notice so when a Renter needs an item, they can pick a timeslot based on the algorithm, without need of back-and-forth messaging. A NOTICE REQUIRED HOURS feature for pickup/delivery slots that are available are crossed linked with minimum notice timeslot hours. This is managed through algorithm flow: Creating Listing (Frontend and Backend, adding field at frontend, passed to backend-> Updating stuff (frontend and backend), updating field at frontend, pass to Backend-> confirm getting stuff feature (frontend and backend), backend reverts information needed to handle available slots which are crossed with minimum timeslot hours input by the Lister, yielding result.

The invention saves on the time needed for back-and-forth communication and cancelation/Decline for delivery or pick up of an item. The lister is able to input a DELIVERY/PICKUP notice in hours and denotes the Time slots they are available. Pick-up and delivery time slots are separate and both have a built-in algorithm that factors in the delay time notice (1hr, 2 hr etc.) that is required by the Lister to prepare the item for Renter pick-up or Delivery. In a typical scenario, a lister offers delivery for a specific listing at 3pm, 5pm, 6pm, 7 pm but includes a Delivery notice time of 1 hour. The renter starts the transaction at 3:14pm; the invention algorithm will incorporate the individualized delivery notice time of 1 hour, taking the current time into consideration for only said particular item thereby letting the module know the earliest time the item can be delivered. In above case, only the time slots after 5:00 pm will be available for renter selection. So, the algorithm will offer 5:00 pm as the earliest slot the lister can deliver. The same algorithm applies to the Pick-up scenario where a preparation time in hours is input by the lister while listing the item. Through the Customized algorithm, different days can offer different customized times.

### DESCRIPTION OF DRAWINGS

FIG. 1 is a screenview of the Delivery Times and Delivery Notice in the Lister's information input page. For item (Boots), the lister selects the times they can deliver and these become shaded boxes. The lister also enters the minimum delivery Notice needed.

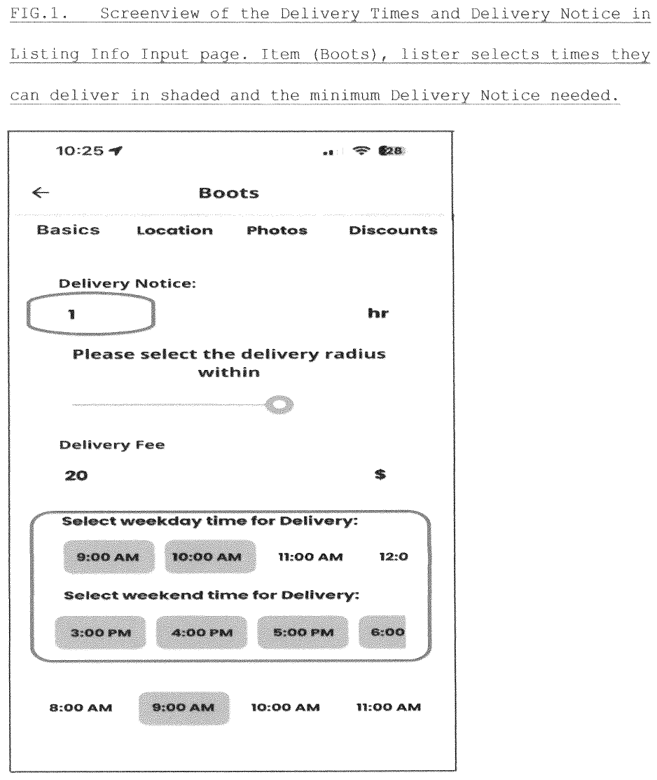

FIG. 2 is the Screen from the renter's view. It shows the details of individualized Delivery Notice input by the lister for each specific item (boots).

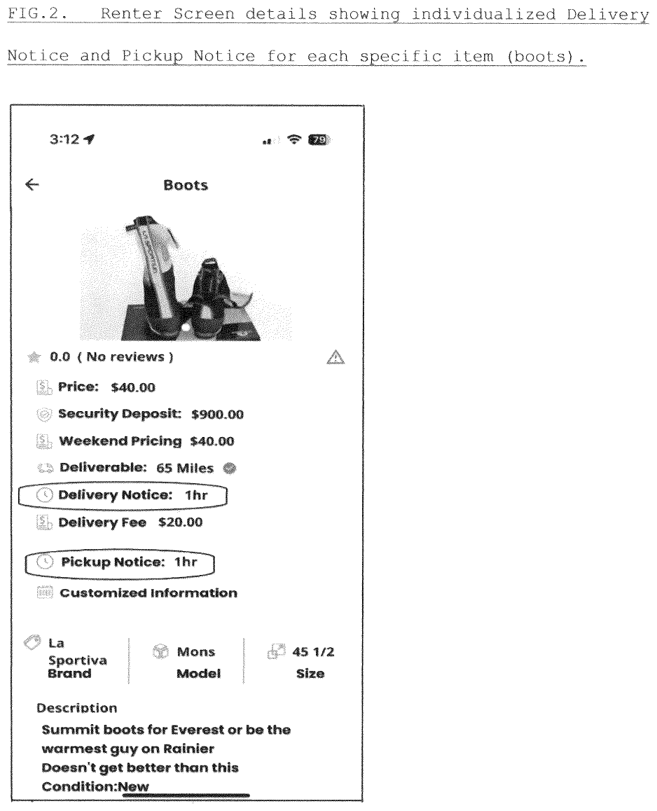

FIG. 3 is the Confirm request form that is visible to the renter after he has selected the item. Here the algorithm derives which slots are available based on the times listed by the lister, based on the current time and based the Delivery notice needed by the lister. Renter sees first available time (5:00 pm) based on the current time (3:14 pm) in white background slot based on the lister entering a 1 hr minimum delivery notice for only this particular item while listing.

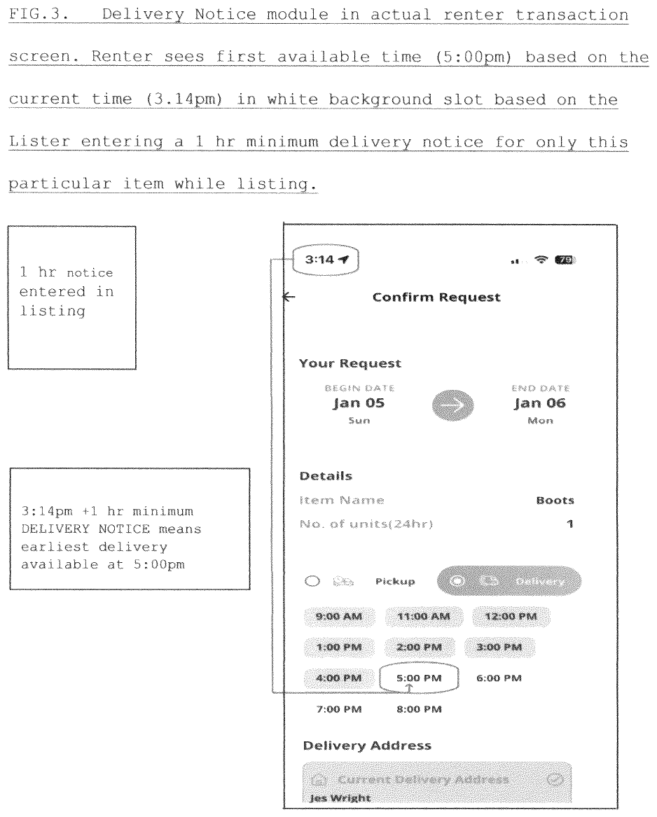

FIG. 4 is the final listing page visible to the lister. The offered timeslots are displayed in shaded background and the pickup notice applicable (1 Hour) is been entered by the lister.

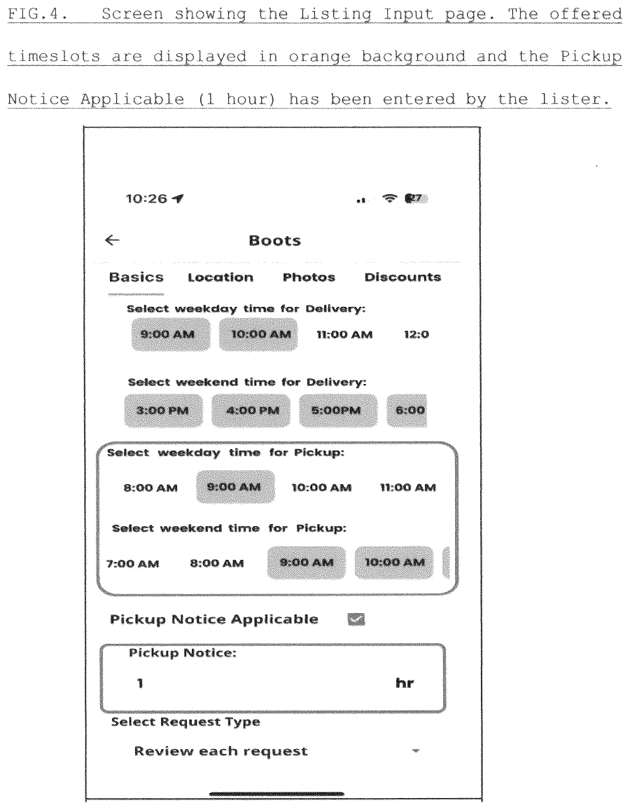

The separate but connected methods of operating the application are as follows:
1. A smartphone application-based system where an individual (renter) may start based on the name of the stuff listed by individual (lister), specifically by name e.g. Boots, yielding a result that displays pricing which is described as the normal price.
2. A listing module that is separate from the everyday price called the Weekend Pricing module which is described as the special price for all the weekends in the year to make up for listers otherwise anticipated loss of income on weekends.
3. An individualized DELIVERY RADIUS in miles specified by the lister stating how far they can deliver the item.
4. An individualized DELIVERY NOTICE module and a PICK-UP NOTICE module wherein the lister provides notice stating how much preparation time is required for the delivery or pick up, being the personal choice made by the lister taking into account all the factors that may hamper the delivery such as loading the item, traffic.
5. An individualized DELIVERY TIME SLOT module where the lister specifies which Time slots can be used (8:00 am, 9:00 am, 2:00 pm). These timeslots are picked in the Listing module and are at the lister's discretion which works with in conjunction with #4 where the algorithm returns timeslots that are not available and the next earliest timeslot and subsequent time slots based on the DELIVERY NOTICE (hours) entered by the lister in #4 relative to the current time.
6. An individualized PICK-UP TIME SLOT module where the lister specifies which Time slots can be used (8:00 am, 9:00 am, 2:00 pm), picked in the Listing module and are at the lister's discretion working in conjunction with #4 where the algorithm returns timeslots that are not available relative to the current time and the next earliest available time slot, including subsequent available time slots based on the PICK-UP NOTICE (hours) entered by the lister in #4.
7. A CUSTOMIZE module where a lister can customize their listing by inputting custom prices for specific periods, specific pickup time slots and specific delivery time slots by overriding the algorithms of methods #2, #5 and #6
8. A customized information module delineating the Delivery slots from #5, Pick up times from #6, specific pickup timeslots and specific delivery timeslots from #7.
9. A custom DISCOUNT module that allows the lister to offer discounts based on a percentage discount for specific periods.
10. A custom PROMOTION module that allows the lister to offer promotions based on percentage which apply to the promotion period only.

What is claimed

1. Receiving by Smartphone, android and IOS, actual verified delivery/pickup possible times based on a smartphone application implemented method where the algorithm exhibits a verified delivery time based on the delivery notice in hours and a verified pickup slot based on the pickup notice that was entered by the lister while listing the item combined with an individualized DELIVERY RADIUS in miles specified by the lister.

2. The individualized DELIVERY NOTICE/PICK UP algorithm wherein the lister provides notice stating how much time is required for the delivery or pick up. The displayed delivery times are determined by the algorithm based on the number of Delivery/Pick up notice hours inserted by the lister to the Current time so timeslots that are before CURRENT TIME+DELIVERY NOTICE/PICK UP NOTICE (hours) will not be available to the renter.

3. A CUSTOMIZE algorithm where a lister can override methods #2, #5 and #6 and customize their listing by offering special prices for specific periods, pickup and specific delivery slots, managed through following flow, creating a listing (Frontend and Backend, adding field at frontend and pass to backend->Updating listing (frontend and backend), updating field at frontend, pass to Backend->confirm requested stuff (item) feature (frontend and backend), backend reverts information needed to handle available time slots which are crossed with minimum timeslot hours inputted by the Lister.
